(19) United States
(12) Patent Application Publication
(10) Pub. No.: US 2015/0370446 A1
(43) Pub. Date: Dec. 24, 2015

(54) Application Specific User Interfaces

(71) Applicant: Google Inc., Mountain View, CA (US)

(72) Inventors: Lei Zhang, Foster City, CA (US); Yao Chen, Freemont (CA); Andy Anderson Stewart, Dalgety Bay (GB)

(21) Appl. No.: 14/310,227

(22) Filed: Jun. 20, 2014

(51) Int. Cl. G06F 3/0481; G06F 17/30; G06F 3/0484

(52) U.S. Cl. CPC G06F 3/04817; G06F 3/0484; G06F 17/3053

(57) ABSTRACT

Systems and techniques are provided for an application specific user interface. A list including a feature for a first media application may be received. The first media application may be run on a first computing device. A template user interface including a definition for a control, including a position within a user interface for the control and a size of the control, may be received. A media application theme may be received for the first media application and may include a color scheme, control icon, logo, or unique control. A translated interface may be generated for the first media application by associating the control of the template user interface with the feature of the first media application and applying the media application theme for the first media application. The translated interface for the first media application may be displayed on the display of a second computing device.

### BACKGROUND

Mobile computing devices, such as smartphones, may be connected to suitable computing devices in a vehicle, such as a car. For example, a car may have head unit with a large display that is capable of connecting to a smartphone via a wired or wireless connection. This may allow the smartphone access to other equipment within the vehicle, such as a stereo system that can be used for audio playback of media stored on the smartphone, or accessible through the smartphone. Application running on the smartphone may be controlled using the vehicles controls, such as a touchscreen on the display of the head unit. However, a smartphone application's user interface may not be suitable for use by a driver while the vehicle is in motion, as the positioning and size of the controls may be difficult. Some of the features of the smartphone application may also be unsafe to use regardless of the design of the user interface, such as, for example, features that require the user to type out messages or perform other actions that would be distracting for the driver of a vehicle.

### BRIEF SUMMARY

According to an embodiment of the disclosed subject matter, a list including a feature for a first media application may be received. The first media application may be run on a first computing device. A template user interface including a definition for a control may be received. The definition may include a position within a user interface for the control and a size of the control. A media application theme may be received for the first media application, the media application theme including a color scheme, control icon, logo, or unique control. A translated interface may be generated for the first media application by associating the control of the template user interface with the feature of the first media application and applying the media application theme for the first media application. The translated interface for the first media application may be displayed on the display of a second computing device.

A second list including a feature for a second media application may be received. The second media application may be run on the first computing device. The feature for the second media application may correspond to the feature for the first media application. The template user interface may be received. A media application theme may be received for the second media application. A translated interface may be generated for the second media application by associating the control of the template user interface with the feature of the second media application and applying the media application theme for the second media application. The translated interface for the second media application on the computing device, wherein the control in the translated interface for the second media application is displayed in the same location as the control in the translated interface for the first media application. The media application theme for the second media application may include a difference from the media application theme for the first media application.

The feature of the first media application may be display information, play, pause, next track, previous track, bookmark, post to social media service, rate positively, rate negatively, shuffle, repeat, or randomize. The first computing device may be a smartphone, a tablet, or a laptop. The second computing device may be a vehicle head unit. The difference may be a different color scheme, different control icons, different logo, or a different unique control. The translated interface for the first media application may be visually distinguishable from the translated interface for the second media application.

According to an embodiment of the disclosed subject matter, a means for receiving a list including a feature for a first media application, wherein the first media application is run on a first computing device, a means for receiving a template user interface including a definition for a control, wherein the definition includes a position within a user interface for the control and a size of the control, a means for receiving a media application theme for the first media application, the media application theme including a color scheme, control icon, logo, or unique control, a means for generating a translated interface for the first media application by associating the control of the template user interface with the feature of the first media application and applying the media application theme for the first media application, a means for displaying the translated interface for the first media application on the display of a second computing device, a means for receiving a second list including a feature for a second media application, where the second media application is run on the first computing device and where the feature for the second media application corresponds to the feature for the first media application, a means for receiving the template user interface, a means for receiving a media application theme for the second media application, a means for generating a translated interface for the second media application by associating the control of the template user interface with the feature of the second media application and applying the media application theme for the second media application, and a means for displaying the translated interface for the second media application on the computing device, where the control in the translated interface for the second media application is displayed in the same location as the control in the translated interface for the first media application, and where the media application theme for the second media application includes a difference from the media application theme for the first media application, are included.

A means for receiving a list of features for a media application, each of the features associated with a control for the media application, a means for ranking the feature on the list of features, a means for receiving a template user interface including definitions for controls, the definition for a control including a position within a user interface for the control and a size of the control, a means for receiving a media application theme defining a color scheme, control icon, logo, or unique control for the media application, a means for associating each feature from the list of features ranked above a threshold with a corresponding definition for a control in the template user interface, a means for applying the media application theme to generate a translated interface, where a feature that does not have corresponding definition for a control is not part of the translated interface, a means for displaying the translated interface to a user, a means for receiving a list of features for a second media application, each of the features associated with a control for the second media application a means for ranking the list of features for the second media application, a means for receiving the template user interface, a means for receiving a second media application theme, a means for associating each feature from the list of features for the second media application ranked above the threshold with a corresponding definition for a control in the template user interface, a means for applying the second media application theme to generate a second translated interface, where a feature for the second media application that corresponds to a feature from the first media application has the same corresponding definition for a control in the template user interface and where the second media application theme differs from the media application theme, a means for displaying the second translated interface to the user, a means for receiving an input to the translated interface, a means for translating the input into a command control for the media application, a means for sending the command control to the media application, a means for receiving media database data from the media application, and a means for displaying the media database data on the translated interface using a control corresponding to an information display feature of the media application, are also included.

Systems and techniques disclosed herein may allow for an interface for an application specific user interface. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for an application specific user interface according to an implementation of the disclosed subject matter.

FIG. 2 shows an example system suitable for an application specific user interface according to an implementation of the disclosed subject matter.

FIG. 3 shows an example arrangement application specific user interface according to an implementation of the disclosed subject matter.

FIG. 4 shows an example arrangement for an application specific user interface according to an implementation of the disclosed subject matter.

FIGS. 5a, 5b, and 5c shows example displays for media applications for use with application specific user interface according to an implementation of the disclosed subject matter.

FIG. 6 shows an example display for an application specific user interface according to an implementation of the disclosed subject matter.

FIG. 7 shows an example of a process for application specific user interface according to an implementation of the disclosed subject matter.

FIG. 8 shows an example of a process for application specific user interface according to an implementation of the disclosed subject matter.

FIG. 9 shows a computer according to an embodiment of the disclosed subject matter.

FIG. 10 shows a network configuration according to an embodiment of the disclosed subject matter.

### DETAILED DESCRIPTION

An application specific user interface may allow the safe use of media applications on a mobile computing device in conjunction with a vehicle-based computing device, while still presenting a unique user interface for different media applications. A mobile computing device, such as a smartphone or tablet, may include a number of media applications, including, for example, music players that playback locally and remotely stored music, subscription-based music players and Internet radio players. Each media application may have its own unique user interface to display on the user's mobile computing device, which may allow the user to interact with and control the media applications via a touchscreen on the mobile computing device. The user may connect the mobile computing device to a vehicle computing device, for example, the head unit of an audio/visual system in a car, for example, using a wired or wireless connection. The user may then use one of the media applications on the mobile computing device, for example, to playback music through the car stereo. The media application may expose, for example, through an Application Programming Interface (API), the various features of the media application and the data accessible by the media application. The vehicle computing device may rank the features of the media application, which may include commands such as play, next track, previous track, and pause, and ranking inputs such as thumbs up and thumbs down. The vehicle computing device may then display, on a display that is part of the vehicle computing device, a user interface translated from a template user interface and the ranking of the features, and customized using a media application theme. The translated interface may include controls that allow the user to access certain features of the media application that are deemed safe to access while driving, while preventing access to other controls. The controls may be presented in a manner that makes them safer for a driver to use than the controls would be if they presented on the display of the vehicle computing device in the same manner as the controls are presented on the display of the mobile computing device by the media application. The template user interface may be used with any media application the user selects to use while the mobile computing device is connected to the vehicle computing device. This may allow for a standardized display for all media applications used through the vehicle computing device while still allowing the media applications to control media playback. Media applications may have their own themes, which may be used to customize the translated interface for the media applications. This may allow the translated interface to include controls for features that are unique to a specific media application, and may also allow for easier identification of which media application is currently being used, based on background colors, overall color scheme, and media application logos displayed with the translated interface.

A mobile computing device, such as, for example, a smartphone or tablet, may include any number of different media applications. Different media applications may have access to different media items from different sources of media, and may have independent media databases stored on the mobile computing device. Media players may have access to media items stored in the local storage of the mobile computing device, media items stored in remote storage accessible by the mobile computing device, or access to media items through subscription services. Media items may include audio tracks, such as music tracks, and videos. For example, a user may install three separate music players on their smartphone. The first and second music player may detect music tracks stored in the local storage of the smartphone, and may build their own separate media databases. The second music player may also have access to music tracks stored by the user in a remote music track storage service, and may include these music tracks as part of its media database, though the tracks may not be part of the media database built by the first music player. The third music player may have access to music tracks through a subscription service, and may have no media database, or, if the service allows for local storage, a media database that includes only music tracks the user has stored locally from the subscription service. These locally stored subscription service music tracks may not appear in the media database for the first or second music player.

The different media applications may also have different user interfaces. Each media application may have a different placements for common media application user interface controls, such as play and pause buttons, and may include their own unique controls, such as thumbs up and thumbs down controls, or other controls for rating media items, or controls for posting messages to social media services. For example, a music player may include a next track, previous track, play, and pause buttons, for controlling playback of locally stored music tracks, while another music player may include only a play, pause, and next track buttons, for controlling playback of music tracks accessed through an Internet radio service which may not allow skipping back to the previous track.

The mobile computing device with the media applications may be connected to a vehicle computing device, which may be, for example, a head unit in a car, truck, or other personal vehicle, or any other type of vehicle. The vehicle computing device may include a display, which may be, for example, a touchscreen in the center console of the vehicle, and may be connected to the vehicle's stereo system, allowing for audio playback. The mobile computing device may be connected to the vehicle computing device in any suitable manner. For example, a smartphone may be connected to a car head unit using a USB cable, a Bluetooth connection, a device-to-device WiFi connection, or to an in-vehicle Wireless LAN. This may allow the vehicle computing device to access various features of the mobile computing device, and may, for example, allow for control of the mobile computing device through the controls for the vehicle computing device. A user may be able to, for example, view applications available on the mobile computing device using the display of the vehicle computing device, for example, through screen sharing or duplication, or through a separate interface that lists the available application, and run the applications. In some implementations, the display of the mobile computing device may also be used as the display for the vehicle computing device, which may not have its own separate display hardware, or may have simple display hardware not suitable for interaction with applications on the mobile computing device. For example, the mobile computing device may be a tablet, and the tablet display may also be used as the display of the vehicle computing device.

A media application may be run on the mobile computing device while the mobile computing device is connected to the vehicle computing device. For example, a user may use the controls for the vehicle computing device, such as a touchscreen display, to select and run a music player on a smartphone that is connected to the vehicle computing device with a USB cable. The media application may include an API that exposes the features of the media application and the data accessible by the media application to the vehicle computing device. The vehicle computing device may include a component, for example, a software application installed on the vehicle computing device or as part of the operating system of the vehicle computing device, which may access the API of the media application to receive a list of the features available in the application. The features may include, for example, controls used by the media application. The vehicle computing device may rank the features of the media application based on, for example, how safe the features are for use by a driver during operation of the vehicle. For example, a play button may be considered very safe and ranked high, while a button that allowed for posting to social media services may be considered unsafe, and ranked low.

The features of the media application may be combined with a template user interface and a media application theme to create a translated interface that may be displayed on the display of the vehicle computing device for the media application running on the mobile computing device. The template user interface may include locations and sizes for the controls or buttons for different features, so that the features of the media application can be controlled through, for example, a touchscreen that is part of the display for the vehicle computing device. For example, the template user interface may have a location for previous track, next track, pause, and play buttons, such that those controls are always displayed in the same location no matter which media application is being run on the mobile computing device. For example, a first music player may include the features of previous track, next track, pause, and play buttons. A second music player may include next track, pause, and play buttons. When either the first or second music player is run on the mobile computing device connected to the vehicle computing device, the common features may be displayed in the same location on the display of the vehicle computing device. When the second music player is running, no previous track button may be displayed. Certain low ranked features may also not have displayed controls. For example, the second music player may include the feature of a button for posting to social media services. The vehicle computing device may rank the button low enough that the button may not be displayed on the display of the vehicle computing device.

Unique features of media applications may also be displayed on the translated interface, and may be taken from, for example a media application theme. For example, a media application may include a bookmark button. When a media application lists a bookmark button among its features, the bookmark button may be taken from the media application theme, which may include a location, size, and icon for the bookmark button, and become part of the translated interface displayed on the display of the vehicle computing device. The translated interface may also have different color schemes for different media applications. For example, a first media application may have a media application theme that includes a blue and white color scheme, which may be applied to the translated interface for the first media application. A second media application may have a media application theme that includes an orange and white color scheme, which may be applied to the translated interface for the second media application. The media application theme may also include an application logo, or different icons for common controls, that may be included in the translated interface. This may allow for the different translated interfaces to be application specific user interfaces, and may make it easier, for example, for a driver to tell which media application is currently being run based on the colors, logos, and other identifiers displayed on the translated interface, despite the identical placement of controls across different translated interfaces for different media applications.

Media application themes may be created by, for example, the creator of the media application, and may be stored with the media application, or may be stored on the vehicle computing device. For example, a media application may send its media application theme to the vehicle computing device to be used in a translated interface whenever the media application is run while the mobile computing device is connected to the vehicle computing device. The media application theme may also be stored on the vehicle computing device, for example, with the template user interface, and retrieved whenever the vehicle computing device creates a translated interface for the media application.

The translated interface for a media application may be used to control the media application in a similar manner to using the media application's user interface on the mobile computing device. Commands issued through the translated interface, for example, by the touching of buttons displayed on the touchscreen of the display of the vehicle computing display, may be sent to the media application running on the mobile computing device. The mobile computing device may respond to the commands as if they were issued through the user interface of the mobile computing device. For example, a user may press the play button on the display of the translated interface, which may result in the media application beginning or resuming playback of a media item. The media application may still have access to any media databases the media application has stored on the mobile computing device and to any local, remote, subscription based, or otherwise accessible media items that media application has access to when run on the mobile computing device. For example, an Internet radio player may still have access to Internet radio stations, a subscription music player may still access music tracks through the subscription service, and a local music player may still play local music tracks based on the media database for the local music player.

Media items played back using a media application on a mobile computing connected to a vehicle computing device may be played through the audio/visual devices attached to the vehicle computing device. For example, the user may use the translated interface to start playback of a music track using a media application on the mobile computing device. The music track may be played through the vehicle's stereo. The audio signal for the music track may be processed through the media application, by hardware and software for audio processing associated with the vehicle computing device and vehicle stereo, or both. This may allow for the use of equalizer settings in media application on mobile computing devices when using the media application to playback audio through the vehicle's stereo.

The API for the media application may also expose data to the vehicle computing device. For example, the API may be used by the vehicle computing device to media database data such as media libraries and playlists, metadata for media items, available Internet radio stations, and other data associated with media applications. This may allow the translated interface to display metadata, for example, artist, album, and track title for music being played back using a media application, and allow the user to browse and select media items in a manner appropriate to the media application. For example, the user may use the translated interface to view available Internet radio stations when running an Internet radio music player on the mobile computing device, or browse a library of available music tracks when using a local music player on the mobile computing device.

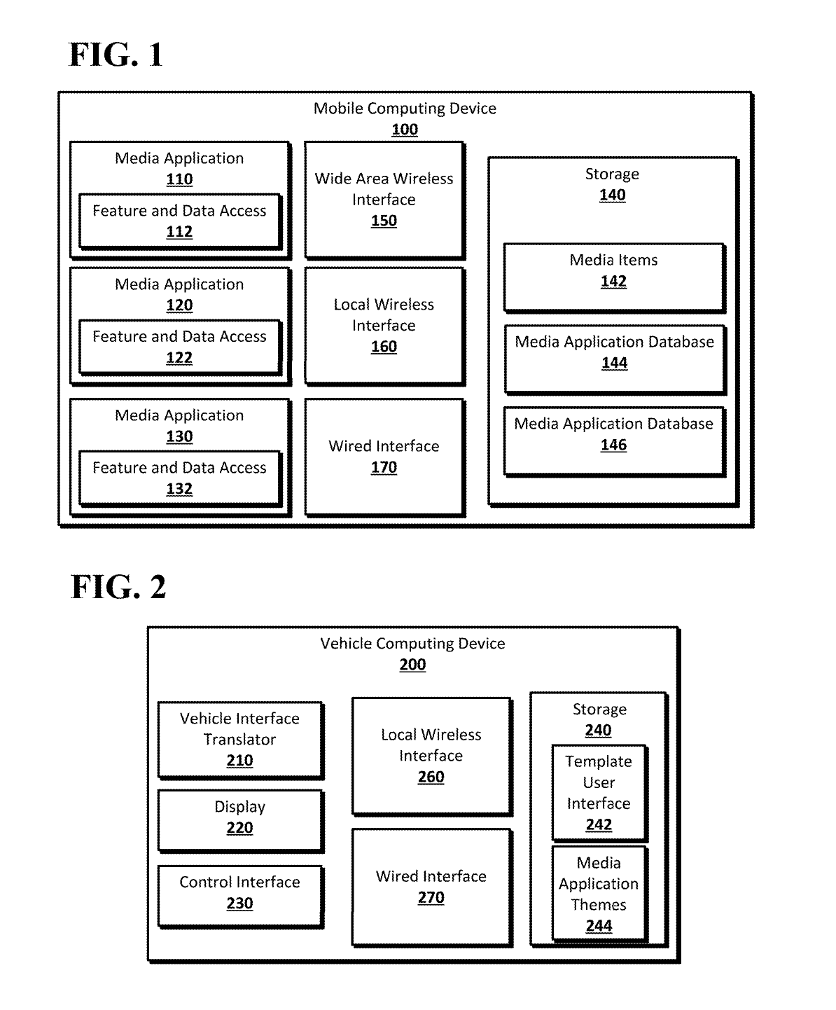

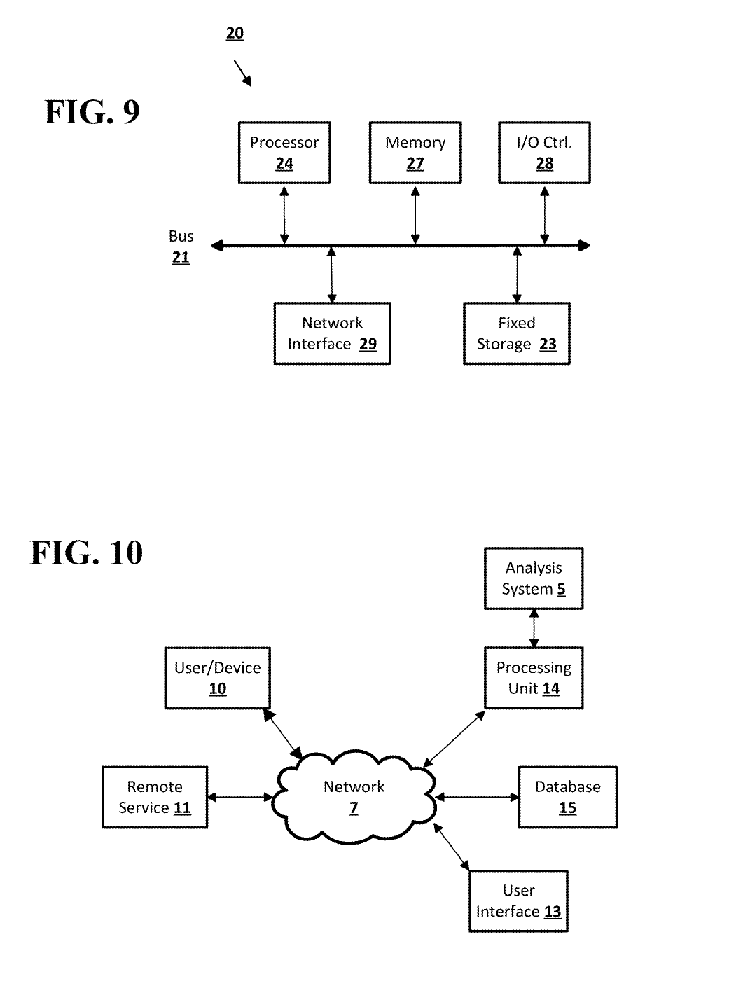

FIG. 1 shows an example system suitable for an interface for multiple media applications according to an implementation of the disclosed subject matter. A mobile computing device 100 may include media applications 110, 120 and 230, a wide area wireless interface 150, a local wireless interface 160, a wired interface 170, and a storage 140. The mobile computing device 100 may be any suitable device, such as, for example, a computer 20 as described in FIG. 9. The mobile computing device 100 may be a single computing device, or may include multiple connected computing devices, and may be, for example, a mobile computing device, such as a tablet, smartphone, or laptop. The media applications 110 and 120 may be used to playback media items 142 from the storage 140, and may build, store, and access the media databases 142 and 144, respectively, in the storage 140. The media application 130 may be used to playback media items accessed using the wide area wireless interface 150. The wide area wireless interface may be using by the mobile computing to access a wide area network. The local wireless interface 160 may be used to connect to local area networks and other devices wirelessly, and the wired interface may be used to connect to other devices using a wired connection. The media applications 110, 120, and 130 may include, respectively, the feature and data access 112, 122, and 132, which may allow each of the media applications 110, 120, and 130, to expose features and data, for example, to other applications. The storage 140 may store the media items 142 and the media databases 144 and 146 in any suitable manner. The media items 142 may be any suitable media items, including, for example, audio tracks such as music tracks.

The media applications 110, 120, and 130, may be any suitable applications for playing back media items, such as the media items 142, on the mobile computing device 100. For example, the media application 110 may be a music player, which may build the media database 144 based on the media items 142. The media application 120 may be a music player which may build the media database 146 based on the media items 142 and media items accessible from remote storage through the wide area interface 150. The media application 130 may be a subscription based music player which may access media items through a subscription music service using the wide area wireless interface 150. Each of the media applications 110, 120, and 130 may include a user interface, which may be displayed on the mobile computing device 100 to allow a user to control the media applications 110, 120, and 130. The media applications 110, 120, and 130, may also include feature and data access 1112, 122, and 132, which may be, for example, an API that may expose the features and data of the media applications 110, 120, and 130. The features may be, for example, the controls used to control each of the media applications 110, 120, and 130, such as, for example, previous track, next track, pause, and play buttons, scrub bars, bookmarks buttons, ratings buttons, and social media service buttons. The exposed data may be, for example, the media database 144 and 146, a media database of a subscription service, available Internet radio or video stations, playlists, and metadata associated with media items including the media items 142.

The wide area wireless interface 150 may be any suitable combination of hardware and software on the mobile computing device 100 for connecting wirelessly to a wide area network such as, for example, the Internet. For example, the wide area wireless interface 150 may use a cellular modem to connect to a cellular service provider, or a WiFi radio to connect to an access point or router that is in turn connected to the Internet. The wide area wireless interface may be used by media applications on the mobile computing device 100 to access media items that are stored remotely, for example, music tracks stored in cloud storage by the user, or music tracks accessed through Internet radio or a subscription music service.

The local wireless interface 160 may be any suitable combination of hardware and software on the mobile computing device 100 for connecting wirelessly to a local area network or other local device. For example, the local wireless interface 160 may use a WiFi radio to connect to a router that has created a local area network, or to connect directly to another device, or may use a Bluetooth radio to connect directly to another device. The local wireless interface 160 may be used by the mobile computing device 100 to connect to another computing device, for example, a computing device in the head unit of a vehicle's audio/visual system. For example, the mobile computing device 100 may establish a connection to the computing device in the head unit over Bluetooth.

The wired interface 170 may be any suitable combination of hardware and software on the mobile computing device 100 for establishing a wired connection to a local area network or other local device. For example, the wired interface 170 may use a USB connection to connect directly to another device. The wired interface 170 may be used by the mobile computing device 100 to connect to another computing device, for example, a computing device in the head unit of a vehicle's audio/visual system. For example, the mobile computing device 100 may establish a connection to the computing device in the head unit using a USB cable.

FIG. 2 shows an example system suitable for an interface for multiple media applications according to an implementation of the disclosed subject matter. A vehicle computing device 200 may include a vehicle interface translator 210, a display 220, a control interface 230, a local wireless interface 260, a wired interface 270, and a storage 240. The vehicle computing device 200 may be any suitable device, such as, for example, a computer 20 as described in FIG. 9. The vehicle computing device 200 may be a single computing device, or may include multiple connected computing devices, and may be, for example, part of the head unit of a vehicle's audio/visual system. The vehicle interface translator 210 may use a template user interface 242 and media application themes 244 from the storage 240 to generate a translated interface that may be displayed on the display 220. The display 220 may be any suitable display device connected to the vehicle computing device 200, and may be used to display the translated interface. The control interface 230 may receive control input from a user, for example, the driver of the vehicle. The storage 240 may store the template user interface 242 and the media application themes 244 in any suitable manner.

The vehicle interface translator 210 may be any suitable combination of hardware and software in the vehicle computing device 200 for accessing the features of media applications on a mobile computing device, for example, the media applications 110, 120, and 130, and using the template user interface 242 and media application themes 244 to generate a translated interface. The vehicle interface translator 210 may access the features through the feature and data access 112, 122, and 132, and may rank the features in order to generate the translated interface. The template user interface 242 may define locations, sizes, and positions, in a user interface for controls for common features of media applications. The translated interface may include controls for features of a specific media application in the locations, and with the size and shape, defined by the template user interface 242 for those controls. The media application themes 244 may include media application themes specific to different media applications. The translated interface may be customized for each media application using a one of the media application themes 244, which may, for example, change the colors use in the translated interface, add controls for features unique to the media application, add logos, or change icons for controls in the translated interface. The vehicle interface translator 210 may also receive media application database data, including, for example, metadata for media items, and display the media application database data to a user using the translated interface on the display 220, and translate commands for a media application received through the control interface 230 to ensure the proper command is sent to the media application. In some implementations, the vehicle interface translator 210 may be run, for example, as an application or operating system component, on the mobile computing device 100.

The display 220 may be any suitable hardware and software for a display device connected to the vehicle computing device 200. For example, the display 220 may be a touchscreen display in the center console of a vehicle. The display 220 may be used to display the translated interface to the user, who may be the driver of the vehicle, and to receive input through a touchscreen interface. The control interface 230 may be, for example, the touchscreen interface of the display 220, and may also include hard and soft keys and other control devices inside the vehicle, such as, for example, play, pause, next track, and previous track buttons located on a steering wheel of the vehicle. In some implementations, the display 220 may be the display on the mobile computing device 100. For example, the mobile computing device 100 may be a tablet with a large screen that may be mounted in a suitable location in the vehicle to be accessible to the driver. The display 220 may also be a display belonging to another computing device. For example, the mobile computing device 100 may be a smartphone, and the display 220 may be the display of a tablet connected to the vehicle computing device 200.

The local wireless interface 260 may be any suitable combination of hardware and software on the vehicle computing device 200 for connecting wirelessly to a local area network or other local device. For example, the local wireless interface 260 may use a WiFi radio to connect to a router that has created a local area network, or to connect directly to another device, or may use a Bluetooth radio to connect directly to another device. The local wireless interface 260 may be used by the vehicle computing device 200 to connect to another computing device, for example, the mobile computing device 100. For example, vehicle computing device 200 may establish a connection to the mobile computing device 100 over Bluetooth.

The wired interface 270 may be any suitable combination of hardware and software on the vehicle computing device 200 for establishing a wired connection to a local area network or other local device. For example, the wired interface 270 may use a USB connection to connect directly to another device. The wired interface 270 may be used by the vehicle computing device 200 to connect to another computing device, for example, the mobile computing device 100.

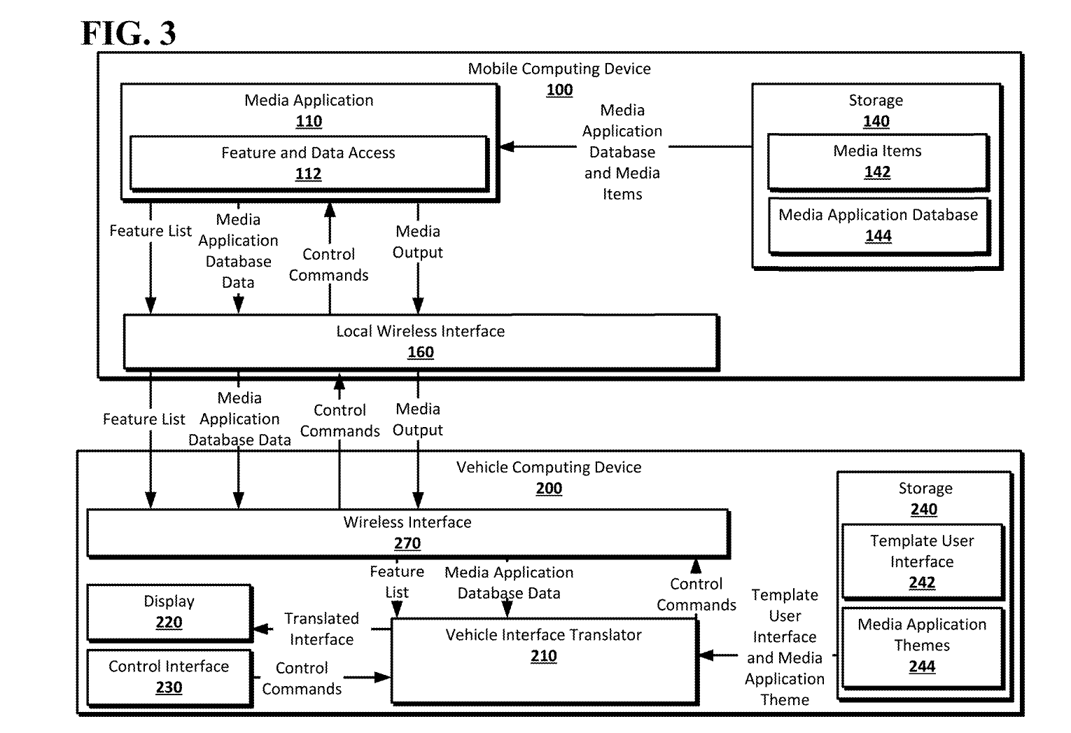

FIG. 3 shows an example arrangement for an interface for multiple media applications according to an implementation of the disclosed subject matter. A user may bring the mobile computing device 100 into a vehicle. For example, a driver may carry their smartphone with them into their car. The mobile computing device 100 may establish a connection to the vehicle computing device 200 using, for example, the local wireless interface 160 of the mobile computing device 100 and local wireless interface 260 of the vehicle computing device 200. For example, the driver's smartphone may connect via Bluetooth to the head unit of a vehicle. The vehicle computing device 200 may be used to select a media application, such as the media application 110, to run on the mobile computing device 100. The display 220 may display all available media applications 110, 120, and 130 on the mobile computing device 100, and the user may use the control interface 230 to select and run the media application 110.

The vehicle interface translator 210 may use the feature and data access 112 to access the features of the media application 110. The features may include, for example, the various controls that would be used on the native user interface of the media application 110, such as previous track, next track, pause, and play buttons. The vehicle interface translator 210 may rank the features of the media application 110, for example, based on how the safe the features are for use by a user who is driving the vehicle. The vehicle interface translator 210 may receive the template user interface 242 and one of the media application themes 244 for the media application 110 from the storage 240, and combine the template user interface 242 and media application theme for the media application 110 with the ranked features to generate a translated interface. The translated interface may include the features of the media application 110 that were ranked highly, for example, deemed safe enough to be used while driving. The translated interface may include controls for the features of the media application 110 in positions defined by the template user interface 242 and by the media application theme from the media application themes 244, and not by the native user interface of the media application 110. For example, the translated interface may include the controls in positions and sizes that make them safer for the driver to use when the translated interface is displayed on the display 220. The translated interface may use a color scheme defined by the media application theme for the media application 110, and may include a logo or other identifiable marking allowing the translated interface to be more easily identified as being for the media application 110.

The translated interface may be displayed on the display 220 of the vehicle computing device 200. The user, for example, the driver of the vehicle, may use the translated interface and the control interface 230 to issue control commands to the media application 110 on the mobile computing device 100. For example, the driver may use a touchscreen of the display 220 to press a play button on the translated interface. The pressing of the play button on the translated interface may be sent to the vehicle interface translator 210, which may translate the control command in order to relay it to the media application 110, for example, using the features and data access 112. For example, the vehicle translator interface 210 may translate the control command into an API call for the media application 110. The media application 110 may receive the control command, and may respond as if the control command had been received through native user interface of the media application 110. This may allow the controls of the translated interface shown on the display 220 to control the media application 110 as the media application 110 were being controlled by its native user interface on the display of the mobile computing device 100. For example, a music player running on a smartphone may be controlled from the display of a vehicle's head unit without requiring that the user issue any commands through the touchscreen of the smartphone. This may allow for safer operation of the media application 110 by the driver of the vehicle, while not requiring that the vehicle computing device 200 implement any of the media access and playback functionality of the media application 110.

The vehicle translator interface 210 may receive media database data from the media application 110, for display on the display 220. For example, the vehicle translator interface 210 may receive, through feature and data access 112, metadata for a currently playing media item from the media items 142, taken from the media database 144. The vehicle translator interface 210 may also receive media library and playlist data taken from the media database 144, to be displayed on the display 220 using the translated interface. This may allow the translated interface to include any data about media items and media selection functionality that may be included in the media application 110, for example, allowing the user to browse through the media items 142 that are accessible to the media application 110 and select media items 142 for playback. For example, a music player on a smartphone may have access to locally stored music tracks, and may have built a library from those music tracks. The translated interface may be used to browse the library built by smartphone, rather than having the vehicle computing device 200 build its own library from the music tracks stored on the smartphone. The translated interface may, though the vehicle translator 210, may allow for use of the media database 144 of the media application 110 as if the native user interface of the media application 110 were being used. The translated interface may use a different format, layout, or controls for accessing the media database 144 through the media application 110, as may be necessary to increase the safety of the use of the translated interface.

The media application 110, controlled by inputs from the control interface 230 to the translated interface on the display 220, may play back media items, for example, from the media items 142. The media items 142 that are played back may be output to the vehicle computing device 100, which may then output the media items 142 appropriately, for example, through the vehicle stereo. The media application 110 may handle any decoding and processing of the media items 142 necessary for playback, for example, converting encoded digital music into analog audio output.

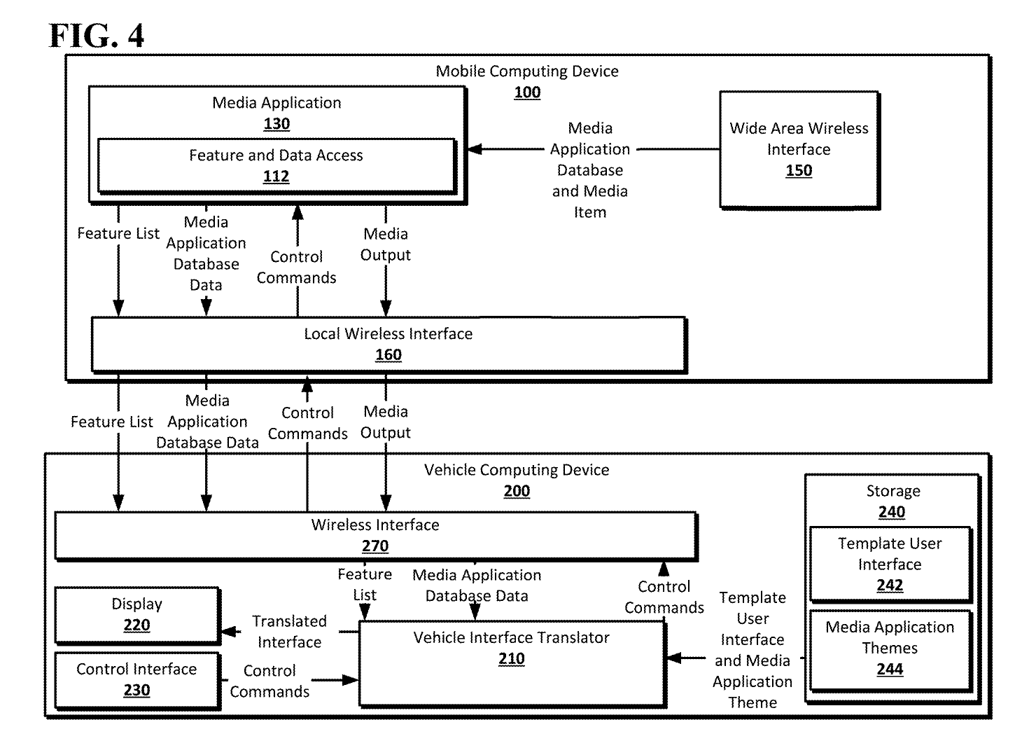

FIG. 4 shows an example arrangement for an interface for multiple media applications according to an implementation of the disclosed subject matter. The vehicle interface translator 210 may be used with any media application on the mobile computing device 100, including, for example, the media application 130. The media application 130 may be, for example, a subscription music player. For example, a user may bring their smartphone into their car, connect the smartphone to the vehicle head unit via Bluetooth, and use the display 220 and control interface 230 to run a subscription music player on the smartphone. The vehicle interface translator 210 may receive the features of the media application 130, rank the features, and generate a translated interface for the media application 130 using the template user interface 242 and a media application theme for the media application 130 from the media application themes 244.

The translated interface may be displayed on the display 220, and may include controls for the features of the media application 130 and a color scheme, logo, control icons and unique controls from the media application theme for the media application 130 that may make the translated interface for the media application 130 more easily distinguishable from the translated interface for the media application 110. The user, for example, the driver, may use the control interface 230 to issue control commands to the media application 130, which may function as if the control commands were received through native user interface of the media application 130. The media application 130 may access media items and media database data through a subscription service, for example, a subscription music service, using the wide are wireless interface 150. The media database data received by the media application 130 from the subscription service through the wide are wireless interface 150 may be passed to the vehicle interface translator 210 and displayed using the translated interface. This may allow the user to control the media application 130 using the control interface 230 and display 220, accessing the data and media items available through the subscription service, and playing back the media items through, for example, the vehicle stereo, as if the user were using the native user interface of the media application 130. The vehicle computing device 200 may not need to be able to access the subscription service itself, as access may be handled through media application 130 on the mobile computing device 100.

The media application 130 may have features in common with the media application 110. The translated interface may include controls for these common features in the same location, having the same size and shape, as defined by the template user interface 242, and different icons, for example, as defined by the media applications themes 244 for the media application 110 and the media application 130. This may allow for easier and safe control of both the media application 110 and the media application 130, as the driver of the vehicle may not have to adjust to different control locations on the display 220 when switching between the media application 110 and the media application 130. This may result in the driver needing to spend less time looking at the display 220 in order to operate a touchscreen interface to control either of the media application 110 and media application 130.

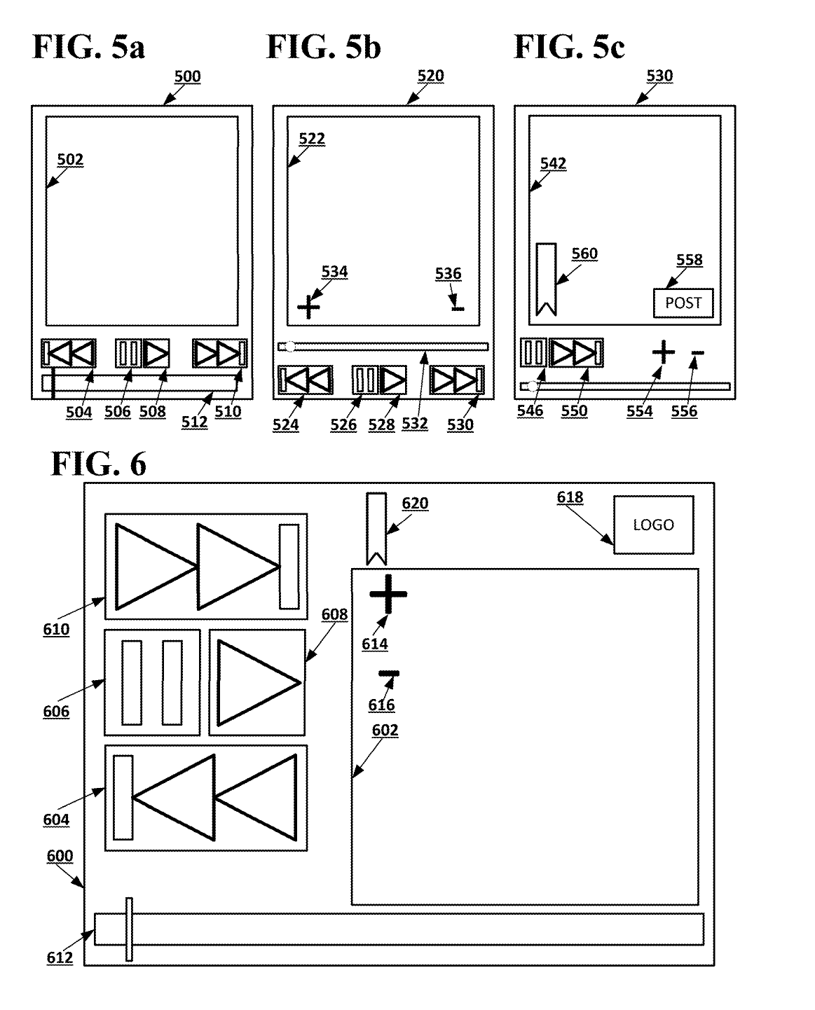

FIGS. 5a, 5b, and 5c shows example displays for media applications for use with an interface for multiple media applications according to an implementation of the disclosed subject matter. Media applications run on the mobile computing device 100, for example, the media applications 110, 120, and 130, may each include a native user interface that may be displayed on the mobile computing device 100 while the media application is in use. The native user interface may include controls for the various features of the media application. A native user interface display 500 may be displayed on a display of the mobile computing device 100 when, for example, the media application 110, which may be a music player for locally stored media items such as the media items 142, is run. The native user interface display 500 may include information area 502 and buttons that control the various features of the media application 110 such as previous track button 504, pause button 506, play button 508, next track button 510, and scrub bar 512. The information area 502 may be used to display information, such as, for example, library or playlist information from the media database 144, or metadata for a currently playing media item, such as a music track, from the media items 142.

A native user interface display 520 may be displayed on a display of the mobile computing device 100 when, for example, the media application 120, which may be a music player for locally stored media items such as the media items 142 and remotely stored media items, for example, media items in cloud storage, is run. The native user interface display 520 may include information area 522 and buttons that control the various features of the media application 110 such as previous track button 524, pause button 526, play button 528, next track button 530, scrub bar 532, positive rating button 534, and negative rating button 536. The information area 522 may be used to display information, such as, for example, library or playlist information from the media database 146, or metadata for a currently playing media item, such as a music track, from the media items 142 or from the remote storage. The buttons for the native user interface display 520 may be arranged differently than those of the native user interface display 500 for the media application 110.

A native user interface display 540 may be displayed on a display of the mobile computing device 100 when, for example, the media application 130, which may be a subscription music player for media items accessed through a subscription music service, is run. The native user interface display 540 may include information area 542 and buttons that control the various features of the media application 130 such as pause button 546, next track button 550, scrub bar 552, positive ranking button 554, negative ranking button 556, a social media service button 558, and a bookmark button 560. The pause button 546 may dynamically switch between pause and play functions depending on whether the current media item is playing or paused. The information area 552 may be used to display information, such as, for example, library or playlist information from the subscription music service, or metadata for a currently playing media item, such as a music track, received from the subscription music service. The native user interface display 540 may have buttons in different locations, and may have fewer or different buttons than, the native user interface displays 500 and 520.

FIG. 6 shows an example display for an interface for multiple media applications according to an implementation of the disclosed subject matter. The template user interface 242 and a media application theme from the media application themes 244 may be used to generate a translated interface display 600. The translated interface display 600 may include information area 602 and buttons that control the various features of a media application running on the mobile computing device 100 that is connected to the vehicle computing device 200, such as previous track button 604, pause button 606, play button 608, next track button 610, and scrub bar 612. For example, the mobile computing device 100 may be connected to the vehicle computing device 200, and the media application 110 may be run on the mobile computing device 100. The vehicle interface translator 210 may receive the features of the media application 110 using the feature and data access 112, rank the features, and use the template user interface 242 to create the translated interface to be displayed on the display 220. The translated interface may use the translated interface display 600. The information area 602 may display the same data that would have been displayed in the information area 502. Selecting the previous track button 604, for example, touching the button on touchscreen control interface 230 for the display 220, may cause the media application 110 to perform the same action, for example, skipping to the previous track, as the previous track button 504. The pause button 606, the play button 608, the next track button 610, and the scrub bar 612 may all be used to control the media application 110 in place of the pause button 506, the play button 508, the next track button 510, and the scrub bar 512. The translated interface display 600 may include a color scheme, for example, background colors and control colors, control icons, and a logo 618 defined by the media application theme for the media application 110. The media application theme may allow the translated interface display 600 to be more easily identifiable as being a translated interface for the media application 110.

The user may switch to the media application 120. The vehicle interface translator 210 may receive the features for the media application 120, and generate the translated interface based on a ranking of the features and media application theme for the media application 120. The translated interface for the media application 120 may also use the translated interface display 600. The information area 602 may display the same data that would have been displayed in the information area 522. Selecting the previous track button 604, for example, touching the button on touchscreen control interface 230 for the display 220, may cause the media application 120 to perform the same action, for example, skipping to the previous track, as the previous track button 524. The pause button 606, the play button 608, the next track button 610, and the scrub bar 612 may all be used to control the media application 110 in place of the pause button 526, the play button 528, the next track button 530, and the scrub bar 532. The translated interface display 600 may additionally include, when generated from the features of the media application 120, positive ranking button 614 and negative ranking button 616, which may control the features normally controlled by positive ranking button 534 and negative ranking button 536. The common features between the media application 110 and the media application 120 may have controls in the same place on the translated interface display 600, even when the controls are in different locations between the native user interface display 500 and the native user interface display 520. The translated interface display 600 for the media application 120 may include a color scheme, for example, background colors and control colors, control icons, and a logo 618 defined by the media application theme for the media application 120. The color scheme, control icons, and logo may be different than those used on the translated interface display 600 generated for the media application 110. The media application theme may allow the translated interface display 600 to be more easily identifiable as being a translated interface for the media application 120.

The user may also switch to the media application 130. The vehicle interface translator 210 may receive the features for the media application 130, and generate the translated interface based on a ranking of the features and the media application theme for the media application 130. The translated interface for the media application 130 may also use the translated interface display 600. The information area 602 may display the same data that would have been displayed in the information area 542. Selecting the next track button 610, for example, touching the button on touchscreen control interface 230 for the display 220, may cause the media application 130 to perform the same action, for example, skipping to the next track, as the next track button 550. The pause button 606, the play button 608, the next track button 610, and the scrub bar 612 may all be used to control the media application 130 in place of the pause button 526, which may have the pause and play features split between the pause button 606 and the play button 608, the next track button 550, and the scrub bar 552. The translated interface display 600 may additionally include, when generated from the features of the media application 130, positive ranking button 614 and negative ranking button 616, which may control the features normally controlled by positive ranking button 554 and negative ranking button 556. The translated interface display 600 may not include a control for the feature controlled by the social media service button 558, as that feature may be deemed to unsafe to be used while driving, and may also not include a control for a previous track feature, and the media application 130 may not include that feature. For example, the media application 130 may be an Internet radio service which not allow for skipping to a previous music track. The translated interface display 600 for the media application 130 may include a color scheme, for example, background colors and control colors, control icons, and a logo 618 defined by the media application theme for the media application 120, and a bookmark button 620 for a unique bookmarking feature of the media application 130 controlled through the native user interface display 540 by the bookmark button 560. The color scheme, control icons, and logo may be different than those used on the translated interface display 600 generated for the media application 110 and the media application 120. The media application theme may allow the translated interface display 600 to be more easily identifiable as being a translated interface for the media application 130.

The common features between any of the media application 110, the media application 120, and the media application 130 may have controls in the same place on the translated interface display 600, even when the controls are in different locations between the native user interface display 500, the native user interface display 520, and the native user interface display 540. This may allow for easier usage of any of the media applications 110, 120, and 130 by a driver using the control interface 230 and the display 220, and the driver does not have to relearn or adjust to changing position controls when switching between media applications running on the mobile computing device 100.

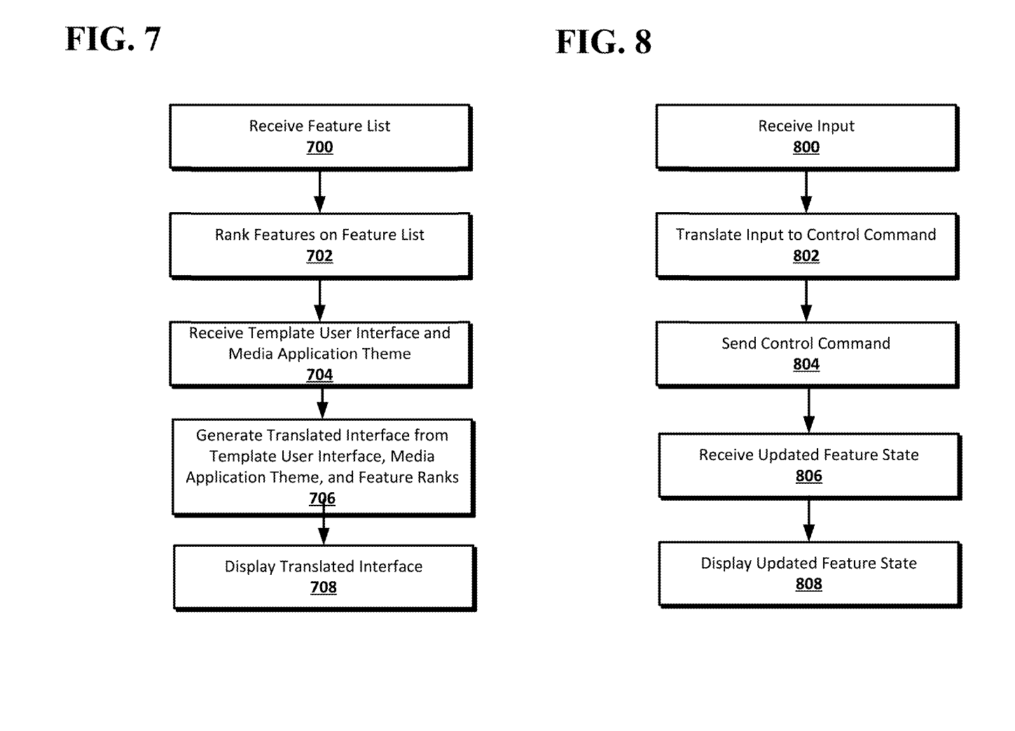

FIG. 7 shows an example of a process for an interface for multiple media application according to an implementation of the disclosed subject matter. At 700, a feature list may be received. For example, the vehicle interface translator 210 may receive a list of the features for the media application 110 using the feature and data access 112. A user may have taken a smartphone into a car, connected the smartphone to the car's head unit, and selected a music player to run on the smartphone.

At 702, the features may be ranked. For example, the vehicle interface translator 210 may rank the features received from the media application 110 according to, for example, how safe the features are to use while driving. Features such as play and pause may be ranked high, as they may be safe to use, while features allowing posting to social media services may be ranked low, as they may be distracting to the driver and unsafe to use.

At 704, a template user interface and media application theme may be received. For example, the vehicle interface translator 210 may receive the template user interface 242 and a media application theme, from the media application themes 244, from the storage 240. The template user interface 242 may include locations, positions, and sizes, for controls for various features of media applications, and may ensure that controls for common features between media applications may appear in the same location and have the same size and shape on the display 220, regardless of which of the media applications 110, 120 and 130 is being run on the mobile computing device 100.

At 706, a translated interface may be generated using the template user interface, the media application theme, and the feature ranks. For example, the vehicle interface translator 210 may generate a translated interface, with the translated interface display 600, connecting the high ranked features for the media application 110 to the appropriate controls defined by the template user interface 242. Controls for features not used by the media application 110 may be omitted from the translated interface, and not appear on the translated interface display 600, as may controls for features that are ranked low because they were deemed unsafe, or controls for features for which there is no corresponding control defined in the template user interface 242, for example, due to the feature being uncommon or unsafe. The translated interface may use a color scheme, control icons, logos, and unique controls defined by the media application theme.

At 708, the translated interface may be displayed. For example, the translated interface may be displayed on the display 220 of the vehicle computing device 200, allowing the driver of the vehicle to control the media application 110 without having to look at or use the mobile computing device 100. The display 220 may, for example, display the translated interface display 600.

FIG. 8 shows an example of a process for an interface for multiple media applications according to an implementation of the disclosed subject matter. At 800, an input may be received. For example, a driver may use the control interface 230, which may be a touchscreen that is part of the display 220, to issue a command to the media application 110. The driver may, for example, select the pause button 606 on the translated interface display 600.

At 802, the input may be translated to a control command. For example, the vehicle interface translator 210 may translate the selection of the pause button 606 into a control command for the media application 110 that will activate the pause feature of the media application 110.

At 804, the control command may be sent. For example, the control command may be sent from the vehicle computing device 200 to the mobile computing device 100, and to the media application 110 using the feature and data access 112, which may be accomplished through, for example, an API call.

At 806, an updated feature state may be received. For example, the pause command may result in the pausing of playback of the media item currently being played back using the media application 110. To reflect the change of playback state, the translated interface display 600 may need to be updated, for example, to pause the motion of a position indicator on the scrub bar 612. The updated feature state may be received at the vehicle interface translator 210.

At 808, the updated feature state may be displayed. For example, translated interface display 600, as displayed on the display 220, may be updated to reflect an updated feature state, for example, pausing the position indicator in the scrub bar 612 to reflect the issuance of a pause command.

Embodiments of the presently disclosed subject matter may be implemented in and used with a variety of component and network architectures. FIG. 9 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 10.

Many other devices or components (not shown) may be connected in a similar manner, such as document scanners, digital cameras, auxiliary, supplemental, or backup systems, or the like. Conversely, all of the components shown in FIG. 9 need not be present to practice the present disclosure. The components can be interconnected in different ways from that shown. The operation of a computer such as that shown in FIG. 9 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 10 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method performed by a data processing apparatus, the method comprising:
receiving a list comprising a feature for a first media application, wherein the first media application is run on a first computing device;
receiving a template user interface comprising a definition for a control, wherein the definition comprises a position within a user interface for the control and a size of the control;
receiving a media application theme for the first media application, the media application theme comprising at least one color scheme, control icon, logo, or unique control;
generating a translated interface for the first media application by associating the control of the template user interface with the feature of the first media application and applying the media application theme for the first media application; and
displaying the translated interface for the first media application on the display of a second computing device.

2. The computer-implemented method of claim 1, further comprising:
receiving a second list comprising a feature for a second media application, wherein the second media application is run on the first computing device and wherein the feature for the second media application corresponds to the feature for the first media application;
receiving the template user interface;
receiving a media application theme for the second media application;
generating a translated interface for the second media application by associating the control of the template user interface with the feature of the second media application and applying the media application theme for the second media application; and
displaying the translated interface for the second media application on the computing device, wherein the control in the translated interface for the second media application is displayed in the same location as the control in the translated interface for the first media application, and wherein the media application theme for the second media application comprises at least one difference from the media application theme for the first media application.

3. The computer-implemented method of claim 1, wherein the feature of the first media application is one of display information, play, pause, next track, previous track, bookmark, post to social media service, rate positively, rate negatively, shuffle, repeat, or randomize.

4. The computer-implemented method of claim 1, wherein the first computing device is one of a smartphone, a tablet, or a laptop.

5. The computer-implemented method of claim 1, wherein the second computing device is a vehicle head unit.

6. The computer-implemented method of claim 2, wherein the difference comprises one of a different color scheme, different control icons, different logo, or different unique control.

7. The computer-implemented method of claim 2, wherein the translated interface for the first media application is visually distinguishable from the translated interface for the second media application.

8. A computer-implemented method performed by a data processing apparatus, the method comprising:
receiving a list of features for a media application, each of the features associated with a control for the media application;
ranking the feature on the list of features;
receiving a template user interface comprising definitions for controls, the definition for a control comprising a position within a user interface for the control and a size of the control;
receiving a media application theme defining at least one of a color scheme, control icon, logo, or unique control for the media application;
associating each feature from the list of features ranked above a threshold with a corresponding definition for a control in the template user interface and applying the media application theme to generate a translated interface, wherein a feature that does not have corresponding definition for a control is not part of the translated interface; and
displaying the translated interface to a user.

9. The computer-implemented method of claim 8, further comprising:
receiving a list of features for a second media application, each of the features associated with a control for the second media application;
ranking the list of features for the second media application;
receiving the template user interface;
receiving a second media application theme;
associating each feature from the list of features for the second media application ranked above the threshold with a corresponding definition for a control in the template user interface and applying the second media application theme to generate a second translated interface, wherein a feature for the second media application that corresponds to a feature from the first media application has the same corresponding definition for a control in the template user interface and wherein the second media application theme differs from the media application theme; and
displaying the second translated interface to the user.

10. The computer-implemented of claim 8, wherein at least one feature is one of display information, play, pause, next track, previous track, bookmark, post to social media service, rate positively, rate negatively, shuffle, repeat, or randomize.

11. The computer-implemented method of claim 8, wherein the media application is run on a mobile computing device and wherein the translated interface is displayed on a vehicle computing device.

12. The computer-implemented method of claim 8, further comprising:
receiving an input to the translated interface;
translating the input into a command control for the media application; and
sending the command control to the media application.

13. The computer-implemented method of claim 8, further comprising:
receiving media database data from the media application; and
displaying the media database data on the translated interface using a control corresponding to an information display feature of the media application.

14. The computer-implemented method of claim 13, wherein the media database data comprises one of: metadata for a currently selected media item or library data for a media database.

15. The computer-implemented method of 8, wherein ranking the features on the list of features is based on the safety of using controls associated with the features while driving a vehicle.

16. A computer-implemented system for an interface for multiple media applications comprising:
a storage comprising a template user interface;
a vehicle interface translator adapted to receive a list of features for a first media application and a list of features for a second media application, rank the features within each list of features, and generate a translated interface for the first media application and a translated interface for the second media application based on the ranked features, the template user interface, and a media application theme for the first media application and a media application theme for the second media application, wherein the translated interface for the first media application and the translated interface for the second media application have at least one common control associated with a feature in common between the first media application and the second media application, the common control having the same position in the translated interface for the first media application and the translated interface for the second media application;
a display adapted to display the translated interface for the first media application and the translated interface for the second media application; and
a control interface adapted to receive inputs to controls of the translated interface for the first media application and the translated interface for the second media application.

17. The computer-implemented system of claim 16, wherein the vehicle interface translator is further adapted to receive the lists of features using an API to access the first media application and the second media application on mobile computing device.

18. The computer-implemented system of claim 16, wherein the vehicle interface translator is further adapted to receive the input to the control interface, translate the input to a command control, and send the command control to the first media application or to the second media application.

19. The computer-implemented system of claim 16, wherein a feature from the lists of features is one of display information, play, pause, next track, previous track, bookmark, post to social media service, rate positively, rate negatively, shuffle, repeat, or randomize.

20. The computer-implemented system of claim 16, wherein the display and control interface form a touchscreen display of a vehicle.

21. The computer-implemented system of claim 16, wherein the vehicle interface translator if further adapted to receive media database data from the first media application and display the media database data on the display using control associated with a display information feature in the translated interface.

22. A system comprising: one or more computers and one or more storage devices storing instructions which are operable, when executed by the one or more computers, to cause the one or more computers to perform operations comprising:
receiving a list comprising a feature for a first media application, wherein the first media application is run on a first computing device;
receiving a template user interface comprising a definition for a control, wherein the definition comprises a position within a user interface for the control and a size of the control;
receiving a media application theme for the first media application, the media application theme comprising at least one color scheme, control icon, logo, or unique control;
generating a translated interface for the first media application by associating the control of the template user interface with the feature of the first media application and applying the media application theme for the first media application; and
displaying the translated interface for the first media application on the display of a second computing device.

23. The system of claim 22, wherein the instructions further cause the one or more computers to perform operations further comprising:
receiving a second list comprising a feature for a second media application, wherein the second media application is run on the first computing device and wherein the feature for the second media application corresponds to the feature for the first media application;
receiving the template user interface;
receiving a media application theme for the second media application;
generating a translated interface for the second media application by associating the control of the template user interface with the feature of the second media application and applying the media application theme for the second media application; and
displaying the translated interface for the second media application on the computing device, wherein the control in the translated interface for the second media application is displayed in the same location as the control in the translated interface for the first media application, and wherein the media application theme for the second media application comprises at least one difference from the media application theme for the first media application.
